(19) United States
(12) Patent Application Publication
(10) Pub. No.: US 2026/0092701 A1
(43) Pub. Date: Apr. 2, 2026

(54) SUPERHEATED-STEAM GENERATING METHOD AND SUPERHEATED-STEAM GENERATING APPARATUS

(71) Applicant: EBARA CORPORATION, Tokyo (JP)

(72) Inventors: Ryota YAMAOKA, Tokyo (JP); Shumpei MIURA, Tokyo (JP); Yasuyuki MOTOSHIMA, Tokyo (JP); Nozomu KUWABARA, Tokyo (JP); Seiya HIGUCHI, Tokyo (JP); Yukihiro KANG, Tokyo (JP)

(21) Appl. No.: 19/336,092

(22) Filed: Sep. 22, 2025

(30) Foreign Application Priority Data
Sep. 27, 2024 (JP) 2024-168072

(51) Int. Cl. F22G 5/00; B24B 37/005; F22G 1/16; G05D 23/19

(52) U.S. Cl. CPC F22G 5/00; B24B 37/005; F22G 1/165; G05D 23/1904

(57) ABSTRACT

A superheated-steam generating method that can quickly generate superheated steam and can prevent the superheated steam from reaching an excessively high temperature is disclosed. The superheated-steam generating method includes: determining a heater-temperature command value for minimizing a temperature difference within a first heater-temperature allowable range set for a first time segment; increasing the first heater-temperature allowable range by a predetermined upward shift amount to determine a second heater-temperature allowable range when the measured value of the temperature of the steam in the first time segment is smaller than the target temperature of the superheated steam and the temperature difference is larger than a first threshold value; and determining the heater-temperature command value for minimizing the temperature difference within the second heater-temperature allowable range set for a second time segment.

### CROSS REFERENCE TO RELATED APPLICATION

This document claims priority to Japanese Patent Application No. 2024-168072 filed Sep. 27, 2024, the entire contents of which are hereby incorporated by reference.

### BACKGROUND

CMP (Chemical Mechanical Polishing) apparatus is used to polish a surface of a wafer in a manufacturing process of semiconductor devices. The CMP apparatus has a polishing head configured to rotate a wafer having a film thereon and press the wafer against a polishing pad on a rotating polishing table to thereby polish the film that constitutes the wafer's surface. During polishing, a polishing liquid (slurry) is supplied onto the polishing pad. The film of the wafer is planarized by a chemical action of the polishing liquid and a mechanical action of abrasive grains contained in the polishing liquid and/or the polishing pad.

A removal rate of the wafer depends not only on a polishing load applied to the wafer on the polishing pad but also on surface temperature of the polishing pad. This is because the chemical action of the polishing liquid on the wafer film depends on temperature. Therefore, it is important to optimize the surface temperature of the polishing pad during polishing of the wafer in order to achieve an appropriate removal rate of the film.

Therefore, a pad-temperature regulating apparatus for regulating a surface temperature of a polishing pad has been conventionally used (see, for example, Japanese laid-open patent publication No. 2022-170648). The pad-temperature regulating apparatus is configured to dispense superheated steam and cooling fluid onto the surface of the polishing pad to thereby regulate the surface temperature of the polishing pad to a desired temperature during wafer polishing.

Water is heated by a heater to form saturated steam, which is further heated to form the superheated steam. Specifically, the water in a liquid phase is heated by the heater and vaporizes, so that liquid and gas (saturated steam) coexist for a while. While the liquid and gas mixture exists, thermal energy from the heater is used for the phase change, and no temperature change occurs. The thermal energy in this state is latent heat. When the enthalpy of the liquid and gas mixture exceeds a critical point, all of the liquid is transformed into steam. This steam is further heated, so that the superheated steam is produced. The thermal energy in this state is sensible heat.

A time required to generate the superheated steam from water depends on an amount of water and a heating temperature of the heater. As mentioned above, the water undergoes the phase change to become the superheated steam, and therefore it takes a certain amount of time to generate the superheated steam from water. Increasing the heating temperature of the heater can shorten the time for generating the superheated steam from water. However, immediately after the transition from the latent heat to the sensible heat, the superheated steam is rapidly heated by the high-temperature heater. Excessively high-temperature superheated steam may thermally deform steam pipes, steam nozzles, etc. On the other hand, lowering the heating temperature of the heater results in a longer time for generating the superheated steam from water.

### SUMMARY

Therefore, there are provided a superheated-steam generating method and a superheated-steam generating apparatus that can quickly generate superheated steam and can prevent the superheated steam from reaching an excessively high temperature.

Embodiments, which will be described below, relate to a technique for generating superheated steam for use in regulating a surface temperature of a polishing pad for polishing a substrate, such as a wafer.

In an embodiment, there is provided a superheated-steam generating method of generating superheated-steam for use in regulating a surface temperature of a polishing pad for polishing a substrate, comprising: heating water to generate steam by a steam generator having a heater; measuring temperature of the steam by a steam-temperature measuring device; and determining, by a feedback controller, a heater-temperature command value indicating a set temperature of the heater for minimizing a temperature difference between a measured value of the temperature of the steam and a target temperature of the superheated steam, wherein determining the heater-temperature command value by the feedback controller comprises: determining the heater-temperature command value for minimizing the temperature difference within a first heater-temperature allowable range set for a first time segment; increasing the first heater-temperature allowable range by a predetermined upward shift amount to determine a second heater-temperature allowable range when the measured value of the temperature of the steam in the first time segment is smaller than the target temperature of the superheated steam and the temperature difference is larger than a first threshold value; and determining the heater-temperature command value for minimizing the temperature difference within the second heater-temperature allowable range set for a second time segment.

In an embodiment, the measured value of the temperature of the steam in the first time segment is an average of temperatures of the steam measured by the steam-temperature measuring device in the first time segment.

In an embodiment, determining the heater-temperature command value by the feedback controller further comprises: determining the heater-temperature command value for minimizing the temperature difference within a third heater-temperature allowable range set for a third time segment; determining a fourth heater-temperature allowable range by lowering the third heater-temperature allowable range by a predetermined downward shift amount when the measured value of the temperature of the steam in the third time segment is larger than the target temperature of the superheated steam and the temperature difference is larger than a second threshold value; and determining the heater-temperature command value for minimizing the temperature difference within the fourth heater-temperature allowable range set for a fourth time segment.

In an embodiment, there is provided a superheated-steam generating apparatus comprising: a steam generator having a heater configured to heat water to generate steam; a steam-temperature measuring device configured to measure temperature of the steam; and a feedback controller configured to determine a heater-temperature command value indicating a set temperature of the heater for minimizing a temperature difference between a measured value of the temperature of the steam and a target temperature of superheated steam, wherein the feedback controller is configured to: determine the heater-temperature command value for minimizing the temperature difference within a first heater-temperature allowable range set for a first time segment; increase the first heater-temperature allowable range by a predetermined upward shift amount to determine a second heater-temperature allowable range when the measured value of the temperature of the steam in the first time segment is smaller than the target temperature of the superheated steam and the temperature difference is larger than a first threshold value; and determine the heater-temperature command value for minimizing the temperature difference within the second heater-temperature allowable range set for a second time segment.

In an embodiment, the feedback controller is configured to calculate an average of temperatures of the steam measured by the steam-temperature measuring device in the first time segment and use the average as the measured value of the temperature of the steam in the first time segment.

In an embodiment, the feedback controller is configured to: determine the heater-temperature command value for minimizing the temperature difference within a third heater-temperature allowable range set for a third time segment; determine a fourth heater-temperature allowable range by lowering the third heater-temperature allowable range by a predetermined downward shift amount when the measured value of the temperature of the steam in the third time segment is larger than the target temperature of the superheated steam and the temperature difference is larger than a second threshold value; and determine the heater-temperature command value for minimizing the temperature difference within the fourth heater-temperature allowable range set for a fourth time segment.

In the process of heating the water with the heater to generate the superheated steam, the feedback controller determines the heater-temperature command value for increasing the heater temperature so that the measured steam temperature approaches the target temperature of the superheated steam. In the first time segment, the heater-temperature command value is limited within the first heater-temperature allowable range. Therefore, even when a difference between the measured steam temperature and the target temperature of the superheated steam is too large, the feedback controller generates the heater-temperature command value that does not exceed an upper limit of the first heater-temperature allowable range. This operation can suppress excessive heat generation of the heater and can prevent the heater from excessively heating the superheated steam when the thermal energy, imparted by the heater, transitions from latent heat to sensible heat.

When the measured value of the steam temperature in the first time segment is smaller than the target temperature of the superheated steam, and when the temperature difference is larger than the first threshold value, the feedback controller increases the first heater-temperature allowable range by the predetermined upward shift amount to determine the second heater-temperature allowable range. In the second time segment, a heater-temperature command value within the second heater-temperature allowable range, which is higher than the first heater-temperature allowable range, is determined. The feedback controller can generate a heater-temperature command value higher than the heater-temperature command value generated in the first time segment. Therefore, the steam generator can quickly bring the steam temperature closer to the target temperature of the superheated steam. As a result, the steam generator can quickly generate the superheated steam.

### BRIEF DESCRIPTION OF THE DRAWINGS

FIG. 1 is a schematic diagram showing an embodiment of a polishing apparatus;

FIG. 2 is a cross-sectional view showing an embodiment of a steam generator;

FIG. 3 is a graph illustrating an embodiment of operation of a feedback controller in a process of generating superheated steam from water via saturated steam; and

FIG. 4 is a schematic diagram showing another embodiment of a polishing apparatus.

### DESCRIPTION OF EMBODIMENTS

Embodiments will now be described with reference to the drawings.

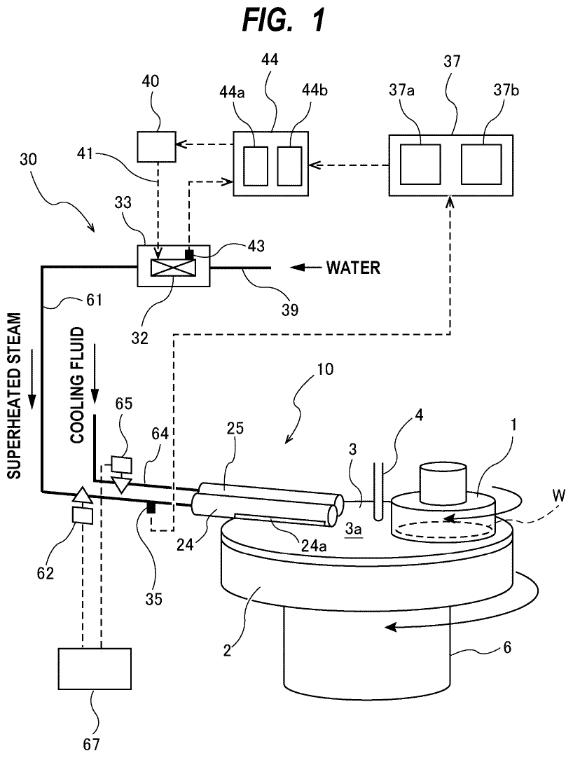

FIG. 1 is a schematic diagram showing an embodiment of a polishing apparatus. The polishing apparatus includes a polishing table 2 configured to support a polishing pad 3 thereon, a polishing head 1 configured to press a wafer W, which is an example of a substrate, against the polishing pad 3, a table-rotating motor 6 configured to rotate the polishing table 2, and a polishing-liquid supply nozzle 4 configured to supply a polishing liquid (e.g., a slurry containing abrasive grains) onto the polishing pad 3. A surface (or an upper surface) of the polishing pad 3 provides a polishing surface 3a for polishing the wafer W. Specific examples of the substrate include a wafer, an interconnect substrate, and a quadrilateral substrate used in manufacturing of semiconductor devices.

Polishing of the wafer W is performed as follows. The wafer W to be polished is rotated by the polishing head 1, while the polishing pad 3 is rotated together with the polishing table 2 by the table-rotating motor 6. In this state, the polishing liquid is supplied onto the polishing surface 3a of the polishing pad 3 from the polishing-liquid supply nozzle 4, and the surface of the wafer W is pressed against the polishing surface 3a of the polishing pad 3 by the polishing head 1. The surface of the wafer W is planarized by a chemical action of the polishing liquid and a mechanical action of the abrasive grains contained in the polishing liquid and/or the polishing pad 3.

The polishing apparatus further includes a pad-temperature regulating system 10 configured to regulate a temperature of the polishing surface 3a of the polishing pad 3 (i.e., a surface temperature of the polishing pad 3). The pad-temperature regulating system 10 includes a pad heater 24 configured to heat the polishing surface 3a of the polishing pad 3, and a pad cooler 25 configured to cool the polishing surface 3a of the polishing pad 3. The pad heater 24 and the pad cooler 25 are located above the polishing table 2 and the polishing pad 3, and are arranged so as to face the polishing surface 3a of the polishing pad 3. The pad heater 24 and the pad cooler 25 are not in contact with the polishing surface 3a of the polishing pad 3.

The pad heater 24 is supplied with superheated steam as a heating fluid. The superheated steam is generated by a process of generating saturated steam from water and further heating the saturated steam. The pad cooler 25 is supplied with a cooling fluid. An example of the cooling fluid is a gas having a room temperature (e.g., an inert gas, such as nitrogen or argon, or air). However, the cooling fluid is not limited to this example. The cooling fluid may be a gas that has been cooled to a temperature lower than the room temperature, or a gas having a temperature lower than a target temperature of the polishing surface 3a of the polishing pad 3.

The pad-temperature regulating system 10 further includes a superheated-steam generating apparatus 30 configured to supply the superheated steam to the pad heater 24. One embodiment of the superheated-steam generating apparatus 30 includes a steam generator 33 having a heater 32 configured to heat water to generate steam, a steam-temperature measuring device 35 configured to measure the temperature of the steam generated by the steam generator 33, and a feedback controller 37 configured to determine a heater-temperature command value that indicates a set temperature of the heater 32 for minimizing a temperature difference which is a difference between a measured value of the temperature of the steam and a target temperature of the superheated steam. The steam generator 33 is coupled to a water supply line 39, so that water is supplied to the steam generator 33 through the water supply line 39. In this embodiment, an electric heater is used as the heater 32. The specific configuration of the steam-temperature measuring device 35 is not particularly limited. For example, a contact-type temperature measuring device or a non-contact-type temperature measuring device may be used.

The superheated-steam generating apparatus 30 includes a voltage controller 40 coupled to the heater 32 via a power line 41, a heater-temperature measuring device 43 configured to measure the temperature of the heater 32, and a heater controller 44 configured to control the heating temperature of the heater 32 based on a measured value of the temperature of the heater 32 and the heater-temperature command value. The heater-temperature measuring device 43 is electrically coupled to the heater controller 44, and the measured value of the temperature of the heater 32 is transmitted from the heater-temperature measuring device 43 to the heater controller 44. One embodiment of the heater controller 44 is a PID controller configured to perform PID operation to minimize a difference between the measured value of the temperature of the heater 32 and a set temperature of the heater 32 indicated by the heater-temperature command value. The specific configuration of the heater-temperature measuring device 43 is not particularly limited, and a contact-type or non-contact-type temperature measuring device is used.

The heater controller 44 includes a memory 44a that stores programs therein and an arithmetic device 44b that executes arithmetic operations according to instructions included in the programs. The heater controller 44 is composed of at least one computer (e.g., a programmable logic controller). The memory 44a includes a main memory, such as a random access memory (RAM), and an auxiliary memory, such as a hard disk drive (HDD) or a solid-state drive (SSD). Examples of the arithmetic device 44b include a central processing unit (CPU) and a graphics processing unit (GPU). However, the specific configuration of the heater controller 44 is not limited to these examples.

The heater controller 44 generates a voltage command value for achieving the set temperature of the heater 32 indicated by the heater-temperature command value transmitted from the feedback controller 37, and transmits the voltage command value to the voltage controller 40. More specifically, the heater controller 44 generates the voltage command value for minimizing the difference between the temperature of the heater 32 measured by the heater-temperature measuring device 43 and the set temperature of the heater 32, and transmits the voltage command value to the voltage controller 40. The voltage controller 40 applies a voltage indicated by the voltage command value to the heater 32, thereby enabling the heater 32 to generate heat at the set temperature indicated by the heater-temperature command value.

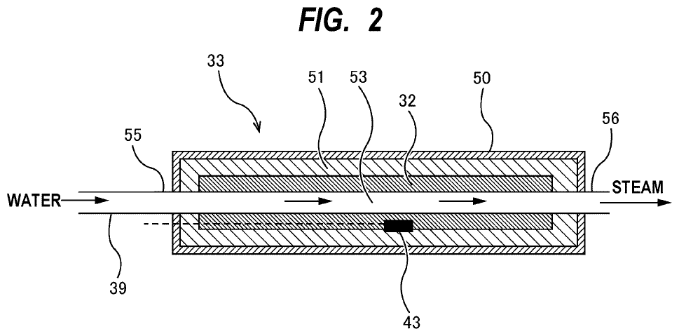

FIG. 2 is a cross-sectional view showing an embodiment of the steam generator 33. The steam generator 33 includes a heater housing 50, a thermal insulator 51 disposed in the heater housing 50, the heater 32 surrounded by the thermal insulator 51, a heating chamber 53 surrounded by the heater 32, and an inlet port 55 and an outlet port 56 communicating with the heating chamber 53. The inlet port 55 is coupled to the water supply line 39. The entire thermal insulator 51 is covered with the heater housing 50. The heater 32 is in contact with a wall surface of the heating chamber 53.

The water flows into the heating chamber 53 through the inlet port 55. The water in the heating chamber 53 is heated by the heat of the wall surface of the heating chamber 53 that is in contact with the heater 32, and is transformed into saturated steam. The saturated steam is further heated by the heat of the wall surface of the heating chamber 53 that is in contact with the heater 32 to become the superheated steam. The superheated steam flows out of the heating chamber 53 through the outlet port 56. The heater-temperature measuring device 43 that measures the temperature of the heater 32 is in contact with the heater 32.

Referring back to FIG. 1, the pad-temperature regulating system 10 further includes a superheated-steam supply line 61 extending from the outlet port 56 (see FIG. 2) of the steam generator 33 to the pad heater 24, a heating flow-rate control valve 62 configured to regulate a flow rate of the superheated steam flowing through the superheated-steam supply line 61, a cooling-fluid supply line 64 configured to supply the cooling fluid to the pad cooler 25, a cooling flow-rate control valve 65 configured to regulate a flow rate of the cooling fluid flowing through the cooling-fluid supply line 64, and a valve controller 67 configured to control operations of the heating flow-rate control valve 62 and the cooling flow-rate control valve 65. The heating flow-rate control valve 62 and the cooling flow-rate control valve 65 are actuator-driven valves, such as electric valves, solenoid valves, or air-operated valves.

The heating flow-rate control valve 62 and the cooling flow-rate control valve 65 are electrically coupled to the valve controller 67, and the operations of the heating flow-rate control valve 62 and the cooling flow-rate control valve 65 (i.e., the flow rate of superheated steam flowing through the superheated-steam supply line 61 and the flow rate of cooling fluid flowing through the cooling-fluid supply line 64) are controlled by the valve controller 67. The valve controller 67 is composed of a computer (e.g., a programmable logic controller) having a memory storing a program therein and an arithmetic device that executes arithmetic operations according to instructions included in the program.

The superheated steam is emitted from an emission opening 24a of the pad heater 24 onto the polishing surface 3a of the polishing pad 3, thereby increasing the temperature of the polishing surface 3a of the polishing pad 3. The cooling fluid is emitted from an emission opening (not shown) of the pad cooler 25 onto the polishing surface 3a of the polishing pad 3, thereby decreasing the temperature of the polishing surface 3a of the polishing pad 3. The valve controller 67 operates the heating flow-rate control valve 62 and the cooling flow-rate control valve 65 to regulate the flow rates of the superheated steam and the cooling fluid supplied from the pad heater 24 and the pad cooler 25 onto the polishing surface 3a of the polishing pad 3, thereby controlling the temperature of the polishing surface 3a of the polishing pad 3.

Although not shown, in one embodiment, the pad-temperature regulating system 10 may further include a suction nozzle adjacent to the pad cooler 25. The suction nozzle has a suction opening facing the polishing surface 3a of the polishing pad 3. The suction nozzle is coupled to a vacuum source, such as a vacuum pump. Increasing or decreasing an amount of air sucked through the suction nozzle can change an amount of heat of vaporization to be removed from the polishing liquid on the polishing surface 3a. As a result, the temperature of the polishing surface 3a can be regulated.

Next, the operation of the feedback controller 37 will be described in detail. The feedback controller 37 includes a memory 37a that stores programs therein and an arithmetic device 37b that executes arithmetic operations according to instructions included in the programs. The feedback controller 37 is composed of at least one computer (e.g., a programmable logic controller). The memory 37a includes a main memory, such as a random access memory (RAM), and an auxiliary memory, such as a hard disk drive (HDD) or a solid-state drive (SSD). Examples of the arithmetic device 37b include a central processing unit (CPU) and a graphics processing unit (GPU). However, the specific configuration of the feedback controller 37 is not limited to these examples.

One embodiment of the feedback controller 37 is a PID controller configured to perform feedback control in accordance with PID operation. The feedback controller 37 is configured to determine (or generate) the heater-temperature command value that indicates the set temperature of the heater 32 for minimizing the difference between the temperature of the steam measured by the steam-temperature measuring device 35 and the target temperature of the superheated steam. The steam-temperature measuring device 35 is mounted to the superheated-steam supply line 61 and measures the temperature of the steam flowing through the superheated-steam supply line 61. The steam-temperature measuring device 35 is electrically coupled to the feedback controller 37, and the measured value of the steam temperature is transmitted from the steam-temperature measuring device 35 to the feedback controller 37.

The steam-temperature measuring device 35 is arranged at a position close to the polishing pad 3, which is the use point of the superheated steam. In one embodiment, the steam-temperature measuring device 35 is arranged immediately upstream of the pad heater 24. For example, the steam-temperature measuring device 35 is arranged upstream of the pad heater 24 and downstream of the heating flow-rate control valve 62. In another embodiment, the steam-temperature measuring device 35 may be arranged inside the pad heater 24. For example, the steam-temperature measuring device 35 may be arranged near the emission opening 24a of the pad heater 24. In this way, the steam-temperature measuring device 35 is arranged at a position close to the polishing pad 3, which is the use point of the superheated steam, so that the steam-temperature measuring device 35 can measure the temperature of the superheated steam immediately before the superheated steam is released onto the polishing pad 3.

The feedback controller 37 monitors the temperature of the steam generated by the steam generator 33 at predetermined time intervals and performs the PID control to minimize the difference between the measured value of the temperature of the steam at each time segment and the target temperature of the superheated steam. If the steam generated by the steam generator 33 is the saturated steam, the difference between the temperature of the saturated steam and the target temperature of the superheated steam is large. Therefore, the feedback controller 37 increases the heater-temperature command value indicating the set temperature (heating temperature) of the heater 32. As a result, the steam generated by the steam generator 33 eventually becomes the superheated steam. Thereafter, the feedback controller 37 determines the heater-temperature command value indicating the set temperature of the heater 32 for minimizing the difference between the current temperature of the superheated steam and the target temperature of the superheated steam.

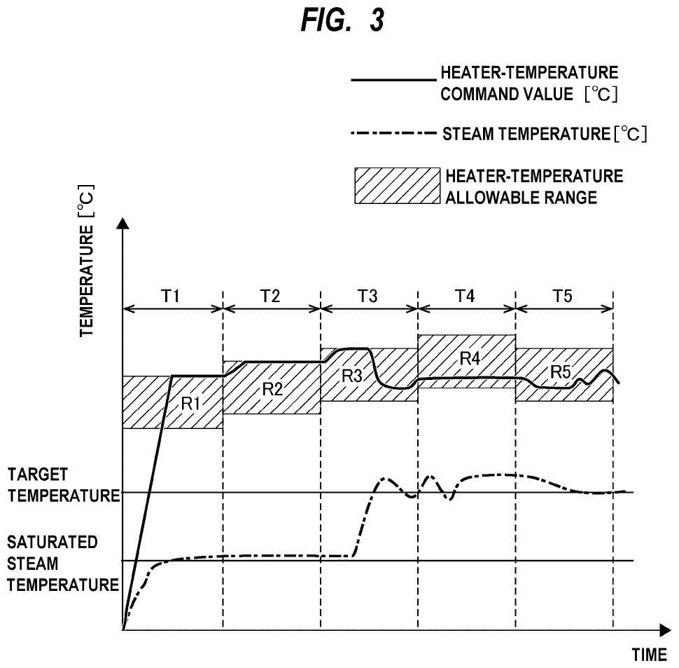

FIG. 3 is a graph illustrating an embodiment of the operation of the feedback controller 37 for generating the superheated steam from the water via the saturated steam. The feedback controller 37 calculates an average temperature of the steam generated by the steam generator 33 in each of time segments T1, T2, T3, T4, and T5. More specifically, the feedback controller 37 calculates an average of multiple steam temperatures measured by the steam-temperature measuring device 35 in each time segment. As a result, averages of the steam temperatures corresponding to the time segments T1, T2, T3, T4, and T5 are calculated.

In one embodiment, the time segments T1, T2, T3, T4, and T5 have the same length (time width). The time segments T1, T2, T3, T4, and T5 shown in FIG. 3 are merely examples, and time segment T5 may be followed by multiple consecutive time segments of the same length. In one embodiment, the length of each of the time segments T1, T2, T3, T4, and T5 is within a range of 5 to 300 seconds. For example, the length of each of the time segments T1, T2, T3, T4, and T5 is 300 seconds. Increasing the length of each of the time segments T1, T2, T3, T4, and T5 to a certain extent can make it possible to control the operation of the heater 32 based on the average of the measurement values of the steam temperature in each time segment, even if a distance between the heater 32, which is the control target, and the measurement point of the steam temperature is long. In one example, a distance between the heater 32 and the steam-temperature measuring device 35 is in a range of 50 mm to 500 mm.

The feedback controller 37 performs the feedback control using the average calculated for each time segment as a measurement value of the steam temperature in that time segment. For example, the average of the steam temperature calculated for the time segment T1 is used as a measurement value of the steam temperature in the time segment T1, and the average of the steam temperature calculated for the time segment T2 is used as a measurement value of the steam temperature in the time segment T2. The same applies to the other time segments T3 to T5.

The average calculated for each time segment may be an arithmetic average of all measured values of the steam temperature obtained in each time segment, or may be the latest moving average of measured values among consecutive measured values of the steam temperature obtained in each time segment.

In the example shown in FIG. 3, the time segment T1 is a time period during which water boils and turns into steam. The thermal energy of the heater 32 at this segment is the latent heat. As can be seen from FIG. 3, the temperature of the steam (or water) during the time segment T1 is significantly different from the target temperature of the superheated steam. In such a case, the feedback controller 37, which is a PID controller, operates to significantly increase the temperature of the heater 32. However, immediately after the transition from the latent heat to the sensible heat, the superheated steam is rapidly heated by the high-temperature heater 32. Excessively high-temperature superheated steam may thermally deform the superheated-steam supply line 61, the pad heater 24, and other structures.

Thus, in this embodiment, heater-temperature allowable ranges R1, R2, R3, R4, and R5 are preset for the time segments T1, T2, T3, T4, and T5, respectively. The heater-temperature allowable ranges R1, R2, R3, R4, and R5 define upper and lower limits of the heater-temperature command value for the corresponding time segments T1, T2, T3, T4, and T5. Therefore, in each time segment, the heater-temperature command value (i.e., the heating temperature of the heater 32) can vary within the corresponding heater-temperature allowable range, but the heater-temperature command value cannot be above the upper limit and below the lower limit of the heater-temperature allowable range. In one embodiment, the upper and lower limits of at least one of the heater-temperature allowable ranges R1, R2, R3, R4, and R5 may be zero.

According to this embodiment, even when the difference between the measured value of the steam temperature in each time segment and the target temperature of the superheated steam is too large, the feedback controller 37 generates the heater-temperature command value that does not exceed the upper limit of each heater-temperature allowable range. This operation can suppress excessive heat generation of the heater 32 and can prevent the heater 32 from excessively heating the superheated steam when the thermal energy of the heater 32 transitions from the latent heat to the sensible heat.

The feedback controller 37 is configured to increase the heater-temperature allowable range for each time segment by a predetermined upward shift amount to determine a new heater-temperature allowable range, when the measured value (e.g., average) of the steam temperature in that time segment is smaller than the target temperature of the superheated steam and when a difference between the measured value of the steam (or water) temperature and the target temperature of the superheated steam (hereinafter simply referred to as temperature difference) is larger than a first threshold value. The feedback controller 37 is configured to then determine a heater-temperature command value for minimizing the temperature difference in the next time segment within the newly determined heater-temperature allowable range.

More specifically, the feedback controller 37 determines a heater-temperature command value for minimizing the temperature difference between the measured value of the steam (or water) temperature and the target temperature of the superheated steam within the heater-temperature allowable range R1 set for the time segment T1. When the measured value of the steam (or water) temperature in the time segment T1 is smaller than the target temperature of the superheated steam and the temperature difference is larger than the first threshold, the feedback controller 37 increases the heater-temperature allowable range R1 by a predetermined upward shift amount to determine a heater-temperature allowable range R2. This heater-temperature allowable range R2 is set as a new heater-temperature allowable range to be used in the next time segment T2. The feedback controller 37 then determines a heater-temperature command value for minimizing the temperature difference between the measured value of steam temperature and the target temperature of the superheated steam within the heater-temperature allowable range R2 set for the time segment T2. Similar control operations are performed for the subsequent time segments T3 to T5.

In the time segment T2, the heater-temperature command value the within heater-temperature allowable range R2, which is higher than the heater-temperature allowable range R1, is determined. The feedback controller 37 can generate the heater-temperature command value higher than the heater-temperature command value generated in the time segment T1. Therefore, the steam generator 33 can quickly bring the steam temperature closer to the target temperature of the superheated steam. As a result, the steam generator 33 can quickly generate the superheated steam.

When the measured value of the steam (or water) temperature in the time segment T1 is smaller than the target temperature of the superheated steam but the temperature difference is smaller than the first threshold value, the feedback controller 37 determines the heater-temperature allowable range R2 for the next time segment T2 using the upper and lower limits of the heater-temperature allowable range R1 as they are. Therefore, the upper and lower limits of the heater-temperature allowable range R2 are the same as the upper and lower limits of the heater-temperature allowable range R1.

The feedback controller 37 is configured to lower the heater-temperature allowable range for each time segment by a predetermined downward shift amount to determine a new heater-temperature allowable range, when the measured value (e.g., average) of the steam temperature in that time segment is larger than the target temperature of the superheated steam and the temperature difference between the measured value of the steam temperature and the target temperature of the superheated steam is larger than a second threshold value. The feedback controller 37 is configured to then determine a heater-temperature command value for the next time segment for minimizing the temperature difference within the newly determined heater-temperature allowable range.

More specifically, the feedback controller 37 determines a heater-temperature command value for minimizing the temperature difference between the measured value of the steam (superheated steam) temperature and the target temperature of the superheated steam within the heater-temperature allowable range R4 set for the time segment T4. When the measured value (e.g., average) of the steam temperature in the time segment T4 is larger than the target temperature of the superheated steam and the temperature difference is larger than the second threshold, the feedback controller 37 lowers the heater-temperature allowable range R4 by a predetermined downward shift amount to determine a heater-temperature allowable range R5. This heater-temperature allowable range R5 is set as a heater-temperature allowable range for the next time segment T5. The feedback controller 37 then determines a heater-temperature command value for minimizing the temperature difference between the measured value of the steam (superheated steam) temperature and the target temperature of the superheated steam within the heater-temperature allowable range R5 set for the time segment T5.

In the time segment T5, a heater-temperature command value within the heater-temperature allowable range R5, which is lower than heater-temperature allowable range R4, is determined. The feedback controller 37 can generate the heater-temperature command value lower than the heater-temperature command value generated in the time segment T4. Therefore, the steam generator 33 can quickly bring the temperature of the steam (superheated steam) closer to the target temperature of the superheated steam.

The second threshold value may be the same as or different from the first threshold value. The upward shift amount and the downward shift amount may be variable depending on the temperature difference between the measured value of the temperature of the steam (superheated steam) and the target temperature of the superheated steam.

If the measured value of the steam temperature in the time segment T4 is larger than the target temperature of the superheated steam but the temperature difference is smaller than the second threshold value, the feedback controller 37 determines the heater-temperature allowable range R5 for the next time segment T5 using the upper and lower limits of the heater-temperature allowable range R4 as they are. Therefore, the upper and lower limits of the heater-temperature allowable range R5 are the same as those of the heater-temperature allowable range R4.

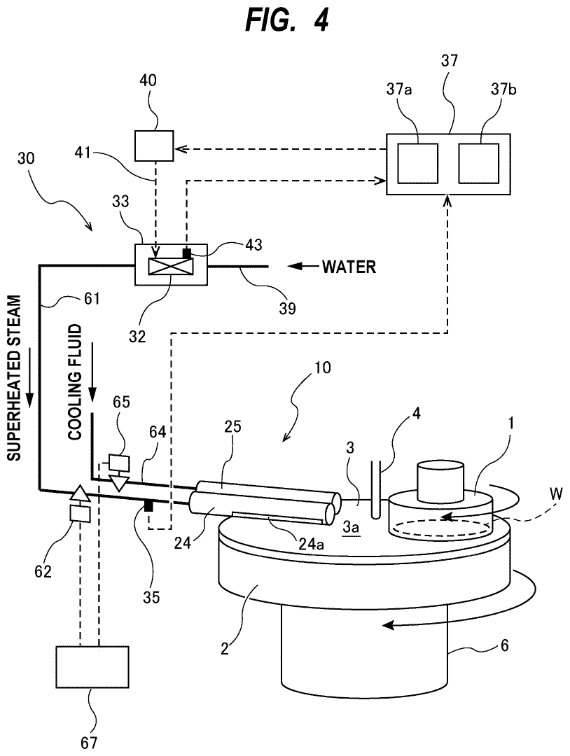

FIG. 4 is a diagram showing another embodiment of the superheated-steam generating apparatus 30. Configuration and operation of this embodiment that will not be specifically described are the same as those described with reference to FIGS. 1 to 3, and therefore redundant description will be omitted. As shown in FIG. 4, the superheated-steam generating apparatus 30 does not include the heater controller 44 shown in FIG. 1. Instead, the feedback controller 37 functions as the heater controller 44 shown in FIG. 1.

The heater-temperature measuring device 43 is electrically coupled to the feedback controller 37, and the measured value of the temperature of the heater 32 is transmitted from the heater-temperature measuring device 43 to the feedback controller 37. The feedback controller 37 generates a voltage command value for achieving a set temperature of the heater 32 indicated by the heater-temperature command value, and transmits the voltage command value to the voltage controller 40. More specifically, the feedback controller 37 generates the voltage command value for minimizing the difference between the temperature of the heater 32 measured by the heater-temperature measuring device 43 and the set temperature of the heater 32, and transmits the voltage command value to the voltage controller 40. The voltage controller 40 applies a voltage indicated by the voltage command value to the heater 32, thereby enabling the heater 32 to generate heat at the set temperature of the heater 32 indicated by the heater-temperature command value.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A superheated-steam generating method of generating superheated-steam for use in regulating a surface temperature of a polishing pad for polishing a substrate, comprising:
heating water to generate steam by a steam generator having a heater;
measuring temperature of the steam by a steam-temperature measuring device; and
determining, by a feedback controller, a heater-temperature command value indicating a set temperature of the heater for minimizing a temperature difference between a measured value of the temperature of the steam and a target temperature of the superheated steam,
wherein determining the heater-temperature command value by the feedback controller comprises:
determining the heater-temperature command value for minimizing the temperature difference within a first heater-temperature allowable range set for a first time segment;
increasing the first heater-temperature allowable range by a predetermined upward shift amount to determine a second heater-temperature allowable range when the measured value of the temperature of the steam in the first time segment is smaller than the target temperature of the superheated steam and the temperature difference is larger than a first threshold value; and
determining the heater-temperature command value for minimizing the temperature difference within the second heater-temperature allowable range set for a second time segment.

2. The superheated-steam generating method according to claim 1, wherein the measured value of the temperature of the steam in the first time segment is an average of temperatures of the steam measured by the steam-temperature measuring device in the first time segment.

3. The superheated-steam generating method according to claim 1, wherein determining the heater-temperature command value by the feedback controller further comprises:
determining the heater-temperature command value for minimizing the temperature difference within a third heater-temperature allowable range set for a third time segment;
determining a fourth heater-temperature allowable range by lowering the third heater-temperature allowable range by a predetermined downward shift amount when the measured value of the temperature of the steam in the third time segment is larger than the target temperature of the superheated steam and the temperature difference is larger than a second threshold value; and
determining the heater-temperature command value for minimizing the temperature difference within the fourth heater-temperature allowable range set for a fourth time segment.

4. A superheated-steam generating apparatus comprising:
a steam generator having a heater configured to heat water to generate steam;
a steam-temperature measuring device configured to measure temperature of the steam; and
a feedback controller configured to determine a heater-temperature command value indicating a set temperature of the heater for minimizing a temperature difference between a measured value of the temperature of the steam and a target temperature of superheated steam,
wherein the feedback controller is configured to:
determine the heater-temperature command value for minimizing the temperature difference within a first heater-temperature allowable range set for a first time segment;
increase the first heater-temperature allowable range by a predetermined upward shift amount to determine a second heater-temperature allowable range when the measured value of the temperature of the steam in the first time segment is smaller than the target temperature of the superheated steam and the temperature difference is larger than a first threshold value; and
determine the heater-temperature command value for minimizing the temperature difference within the second heater-temperature allowable range set for a second time segment.

5. The superheated-steam generating apparatus according to claim 4, wherein the feedback controller is configured to calculate an average of temperatures of the steam measured by the steam-temperature measuring device in the first time segment and use the average as the measured value of the temperature of the steam in the first time segment.

6. The superheated-steam generating apparatus according to claim 4, wherein the feedback controller is configured to:
determine the heater-temperature command value for minimizing the temperature difference within a third heater-temperature allowable range set for a third time segment;
determine a fourth heater-temperature allowable range by lowering the third heater-temperature allowable range by a predetermined downward shift amount when the measured value of the temperature of the steam in the third time segment is larger than the target temperature of the superheated steam and the temperature difference is larger than a second threshold value; and
determine the heater-temperature command value for minimizing the temperature difference within the fourth heater-temperature allowable range set for a fourth time segment.
